(19) United States
(12) Patent Application Publication
(10) Pub. No.: US 2025/0245016 A1
(43) Pub. Date: Jul. 31, 2025

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: KUNIMASA FUJISAWA, Kanagawa (JP)

(21) Appl. No.: 19/035,469

(22) Filed: Jan. 23, 2025

(30) Foreign Application Priority Data
Jan. 25, 2024 (JP) 2024-009390

(51) Int. Cl. G06F 9/4401

(52) U.S. Cl. CPC G06F 9/4403; G06F 9/442

(57) ABSTRACT

An information processing apparatus includes a first acquisition unit configured to acquire a first list containing information about each of processes in a set configured to be restarted, a second acquisition unit configured to acquire a second list containing information about each of processes in a set in operation, an extraction unit configured to extract one or more processes about which information is contained in the first list, from the set of processes about which information is contained in the second list, a calculation unit configured to calculate total memory usage of each of the one or more processes extracted by the extraction unit, a determination unit configured to determine whether the total memory usage calculated by the calculation unit exceeds a threshold, and a restart unit configured to restart at least one of the processes extracted by the extraction unit if the total memory usage exceeds the threshold.

### BACKGROUND

### Field of the Disclosure

The present disclosure relates to an information processing apparatus, a method for controlling the information processing apparatus, and a storage medium.

### Description of the Related Art

In recent years, there has been an increasing number of cases where not only information processing apparatuses, such as personal computers (PCs) or servers, but also image processing apparatuses are connected to network services (e.g., cloud services) on networks, such as the Internet. Given this background, a configuration that enables software to operate for using network services, such as web browsers, may also be applied to the apparatuses exemplified above. Consequently, various software processes are also beginning to operate even in apparatuses with relatively smaller memory capacities, such as those described above, compared to PCs or servers.

Japanese Patent Application Laid-Open No. 2001-331348 discusses a process memory consumption increase trend detection method that automatically monitors trends in memory consumption increase to ensure stable and continuous operation of a computer system.

When a process that consumes a relatively large amount of memory, such as a web browser, operates on an apparatus with relatively small memory capacity, other processes may be forcibly terminated by an operating system (OS).

Under such circumstances, the stability of the operation of the apparatus may be impaired depending on which process is forcibly terminated.

### SUMMARY

The present disclosure is directed to ensuring stability of operation more effectively even in apparatuses with relatively small memory capacity.

According to an aspect of the present disclosure, An information processing apparatus comprising at least one memory and at least one processor which function as a first acquisition unit configured to acquire a first list containing information about each of processes in a set configured to be restarted, a second acquisition unit configured to acquire a second list containing information about each of processes in a set in operation, an extraction unit configured to extract one or more processes about which information is contained in the first list, from the set of processes about which information is contained in the second list, a calculation unit configured to calculate total memory usage of each of the one or more processes extracted by the extraction unit, a determination unit configured to determine whether the total memory usage calculated by the calculation unit exceeds a threshold, and a restart unit configured to restart at least one of the one or more processes extracted by the extraction unit in a case where the determination unit determines that the total memory usage exceeds the threshold.

Further features of the present disclosure will become apparent from the following description of exemplary embodiments with reference to the attached drawings.

### BRIEF DESCRIPTION OF THE DRAWINGS

FIG. 1 is a diagram illustrating an example of a hardware configuration of an image processing apparatus.

FIG. 2 is a diagram illustrating an example of a software configuration of the image processing apparatus.

FIG. 3 is a diagram illustrating an example of a process information list.

FIG. 4 is a flowchart illustrating an example of a process of the image processing apparatus.

FIG. 5 is a diagram illustrating an example of a software configuration of an image processing apparatus.

FIG. 6 is a flowchart illustrating an example of a process of the image processing apparatus.

### DESCRIPTION OF THE EMBODIMENTS

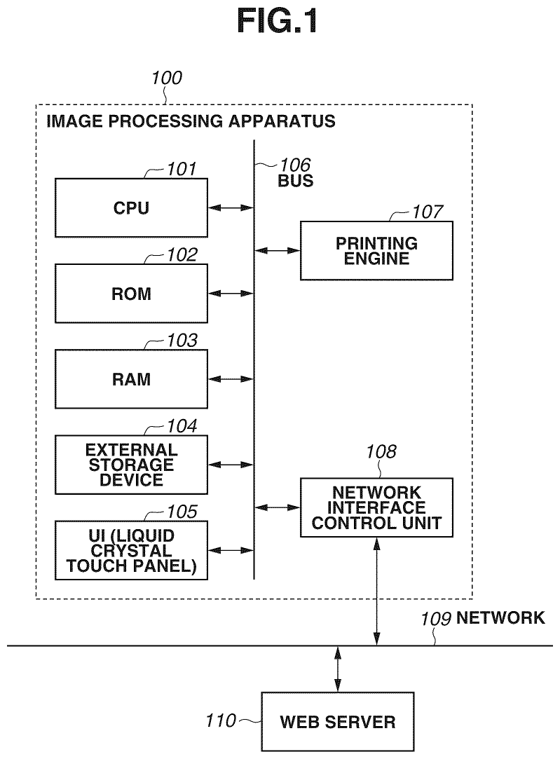

An example of a hardware configuration of an image processing apparatus 100 according to an embodiment of the present disclosure will be described below with reference to FIG. 1. The image processing apparatus 100 corresponds to an example of an information processing apparatus according to an embodiment of the present disclosure.

The image processing apparatus 100 includes a central processing unit (CPU) 101, a read-only memory (ROM) 102, a random access memory (RAM) 103, and an external storage device 104. Further, the image processing apparatus 100 includes a user interface (UI) 105, a printing engine 107, and a network interface control unit 108. The foregoing components of the image processing apparatus 100 are connected to transmit and receive data to and from each other via a bus 106.

The CPU 101 corresponds to a control device (central processing unit) that controls the entire apparatus and comprehensively controls the operation of each component connected via the bus 106. Further, the CPU 101 realizes the functions of the image processing apparatus 100 according to the present embodiment by executing software programs stored in predetermined storage areas (e.g., the ROM 102, the RAM 103, and the external storage device 104).

The ROM 102 is a storage area in which various software programs are stored.

The RAM 103 is a temporary storage area used as a main memory for the CPU 101 and as a workspace.

The external storage device 104 is a storage area for storing various programs and various types of data and may store, for example, the software programs for realizing the functions of the image processing apparatus 100 according to the present embodiment.

The CPU 101 realizes the functions of the image processing apparatus 100 according to the present embodiment by, for example, loading programs stored in the ROM 102 or the external storage device 104 into the RAM 103 and executing the programs.

The UI 105 corresponds to a user interface for receiving inputs from users and presenting information to users. The UI 105 may be implemented using, for example, a liquid crystal touch panel or a combination of a liquid crystal panel and hardware keys. Further, the image processing apparatus 100 according to the present embodiment may use the UI 105 to display a web browser.

The printing engine 107 performs various processes related to printing.

The network interface control unit 108 serves the role of an interface for connecting the image processing apparatus 100 to a predetermined network. In the example illustrated in FIG. 1, the image processing apparatus 100 is connected to a network 109 via the network interface control unit 108. The type of the network 109 is not specifically restricted and may be, for example, the Internet or a local area network (LAN). Further, the network 109 may be a wired network or a wireless network. Further, the device used as the network interface control unit 108 to connect to the network 109 may be changed depending on the type of the network 109.

In the example illustrated in FIG. 1, a web server 110 is connected to the network 109.

The web server 110 transmits web contents to the web browser in response to a request from the web browser.

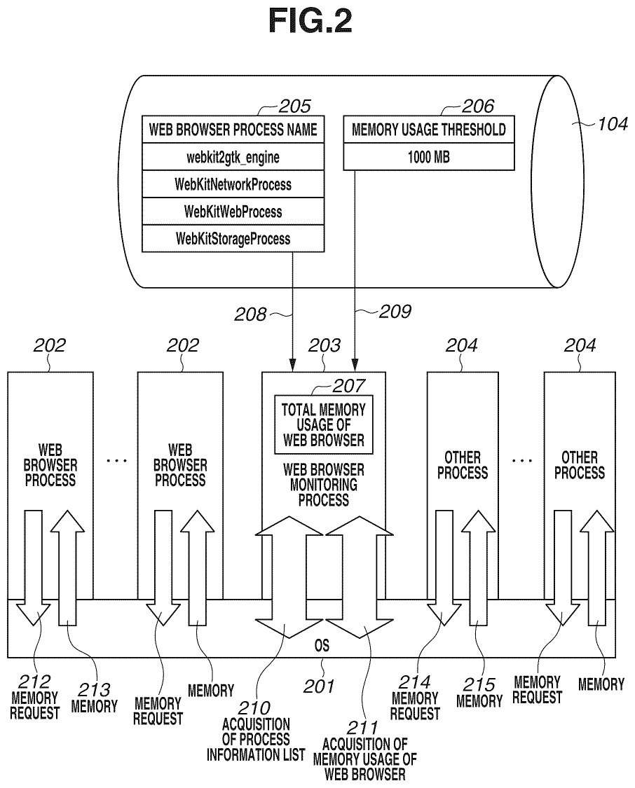

An example of a software configuration of the image processing apparatus 100 according to the present embodiment will be described below with reference to FIG. 2.

In the example illustrated in FIG. 2, one or more web browser processes 202 making up the web browser and other processes 204 for implementing other functions run on an operating system (OS) 201. Further, in addition to the foregoing processes, a web browser monitoring process 203 also runs on the OS 201.

Each web browser process 202 issues a memory request for the allocation of memory required for operation to the OS 201, as indicated by reference numeral 212. The OS 201 allocates memory to the web browser process 202, as indicated by reference numeral 213, in response to the memory request indicated by the reference numeral 212.

Each other process 204 issues a memory request for the allocation of memory required for operation to the OS 201, as indicated by reference numeral 214. The OS 201 allocates memory to the other process 204, as indicated by reference numeral 215, in response to the memory request indicated by the reference numeral 214.

The web browser monitoring process 203 reads a web browser process name list 205 for identifying web browser processes from the external storage device 104, as indicated by reference numeral 208. Further, the web browser monitoring process 203 reads a memory usage threshold 206, which defines the memory capacity available to the web browser processes, from the external storage device 104, as indicated by reference numeral 209. The memory usage threshold 206 is set to a value corresponding to the memory capacity that has been confirmed to prevent the other process 204 from being forcibly terminated.

According to the present embodiment, the web browser process name list 205 corresponds to an example of a first list containing information about each of the processes in the set configured to be restarted, and in this case, the web browser processes correspond to an example of the processes configured to be restarted.

Upon receiving a memory request from the web browser process 202 or the other process 204, the OS 201 begins memory allocation to the request source process, starting with the RAM 103. If the RAM 103 becomes insufficient, the OS 201 creates a swap file on the external storage device 104 and writes unused data on the RAM 103 allocated to the process to the swap file on the external storage device 104. In a case where the process attempts to access the data on the swap file, the OS 201 returns the data on the swap file to the RAM 103 and makes the data available for use by the process.

The web browser monitoring process 203 stores total memory usage 207 of the web browser, which is the total amount of memory size used by the web browser process. The web browser monitoring process 203 acquires, from the OS 201, a process information list (hereinafter, also referred to as “process information list 301”) of processes running on the image processing apparatus 100, as indicated by reference numeral 210. The web browser monitoring process 203 acquires, from the OS 201, the memory usage of the web browser identified from the web browser process name list 205, as indicated by reference numeral 211.

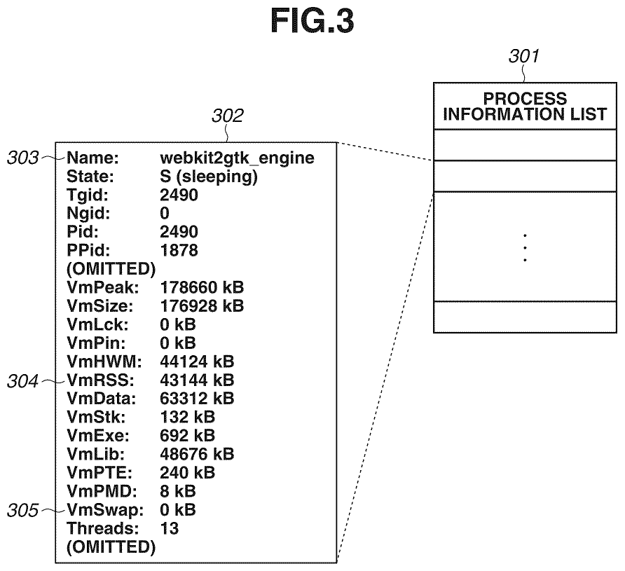

An example of the process information list 301 will be described below with reference to FIG. 3. The process information list 301 is a list containing process information 302. The process information 302 contains various types of information about target processes. Specific examples of information described in the process information 302 include a process name 303 indicating a process name, a VmRSS value 304 indicating the capacity of a physical memory that is used, and a VmSwap value 305 indicating the capacity of a swap memory that is used.

The memory of the image processing apparatus 100 consists of the physical memory and the swap memory. Accordingly, the sum of the VmRSS value 304 and the VmSwap value 305 used by the web browser process represents the memory capacity used by the web browser process within the total memory of the image processing apparatus 100.

According to the present embodiment, the process information list 301 corresponds to an example of a second list containing information about each of processes in a set in operation.

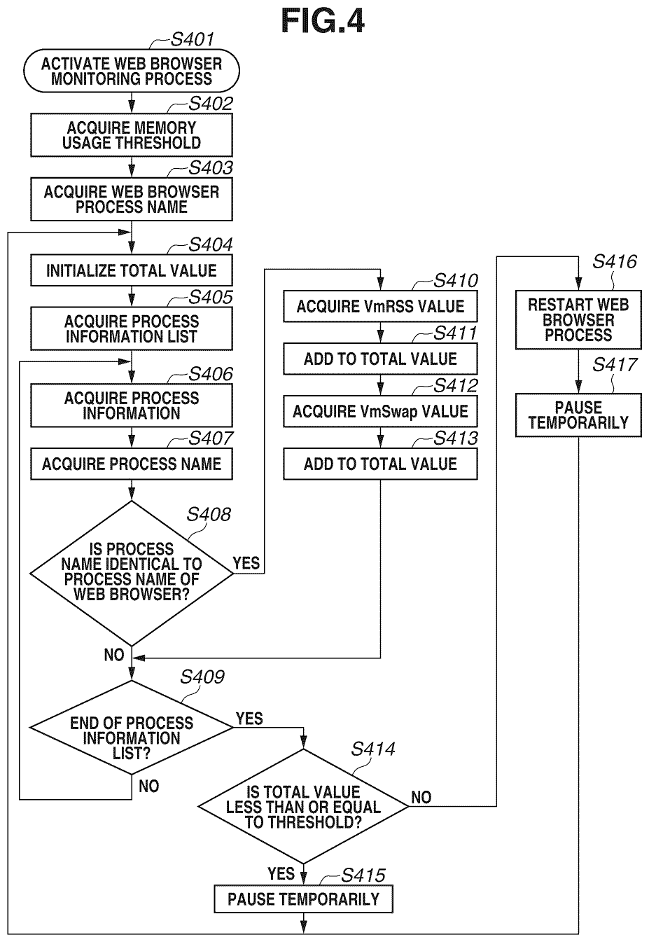

An example of a process of the image processing apparatus 100 according to the present embodiment will be described below with reference to FIG. 4, with a particular focus on the operations of the web browser monitoring process 203.

In step S401, the web browser monitoring process 203 is activated in conjunction with activation of the image processing apparatus 100 and starts a set of processes illustrated in FIG. 4. In practice, the CPU 101 of the image processing apparatus 100 functions as the main entity responsible for the set of processes in the example illustrated in FIG. 4. For convenience, however, the web browser monitoring process 203 will be described as the main entity responsible for the processes.

In step S402, the web browser monitoring process 203 reads the memory usage threshold 206, which indicates the amount of memory available to the web browser, from the external storage device 104.

In step S403, the web browser monitoring process 203 reads the web browser process name list 205 for identifying web browser processes from the external storage device 104. The process in step S403 corresponds to a first acquisition process of acquiring the first list (the web browser process name list 205).

In step S404, the web browser monitoring process 203 initializes the value of the total memory usage 207 of the web browser to zero.

In step S405, the web browser monitoring process 203 acquires the process information list 301 from the OS 201. The process in step S405 corresponds to a second acquisition process of acquiring the second list (the process information list 301).

In step S406, the web browser monitoring process 203 acquires one piece of process information 302 from the process information list 301 acquired in step S405.

In step S407, the web browser monitoring process 203 acquires the process name 303 from the process information 302 acquired in step S406.

In step S408, the web browser monitoring process 203 determines whether the process name 303 acquired in step S407 is identical to the process name of the web browser contained in the web browser process name list 205 read in step S403. In a case where the web browser monitoring process 203 determines that the process name 303 in question is identical to the process name of the web browser contained in the web browser process name list 205 (YES in step S408), the processing proceeds to step S410, whereas in a case where the process name 303 in question is determined not to be identical (NO in step S408), the processing proceeds to step S409. Specifically, in a case where the process name 303 acquired in step S407 is contained in the web browser process name list 205 read in step S403, the process corresponding to the process name 303 is extracted as a target (monitoring target) of the processes in steps S410 to S414 described below.

In step S409, the web browser monitoring process 203 determines whether the determination in step S408 has been performed on all process information 302 up to the end of the process information list 301. In a case where the web browser monitoring process 203 determines that the determination in step S408 has been performed on all process information 302 up to the end of the process information list 301 (YES in step S409), the processing proceeds to step S414, whereas in a case where the web browser monitoring process 203 determines that the determination in step S408 has not been performed on all process information 302 up to the end of the process information list 301 (NO in step S409), the processing proceeds to step S406. In the case where the processing proceeds to step S406, the web browser monitoring process 203 acquires one piece of process information 302 from the process information list 301 that has not yet undergone determination in step S408 and sets the acquired information as a target for the processes beginning from step S407.

In step S410, the web browser monitoring process 203 acquires the VmRSS value 304 from the process information 302 acquired in step S406.

In step S411, the web browser monitoring process 203 adds the VmRSS value 304 acquired in step S410 to the total memory usage 207 of the web browser.

In step S412, the web browser monitoring process 203 acquires the VmSwap value 305 from the process information 302 acquired in step S406.

In step S413, the web browser monitoring process 203 adds the VmSwap value 305 acquired in step S412 to the total memory usage 207 of the web browser.

Thus, the capacity of the memory (physical memory and swap memory) used by the process (the web browser process 202) extracted as a monitoring target through the processes in steps S406 and S407 is added to the total memory usage 207 of the web browser.

Thereafter, the processing proceeds to step S409.

In step S414, the web browser monitoring process 203 determines whether the total memory usage 207 of the web browser is less than or equal to the memory usage threshold 206. At this time, the total memory usage 207 of the web browser is set to the total capacity of the memory used by each of the processes in the set sequentially extracted as a monitoring target through the processes in steps S406 and S407, i.e., the set of web browser processes 202 in operation. In a case where the web browser monitoring process 203 determines that the total memory usage 207 of the web browser is less than or equal to the memory usage threshold 206 (YES in step S414), the processing proceeds to step S415, whereas in a case where the web browser monitoring process 203 determines that the total memory usage 207 of the web browser is neither less than nor equal to the memory usage threshold 206 (NO in step S414), the processing proceeds to step S416.

In step S416, the web browser monitoring process 203 restarts the process (the web browser process 202) making up the web browser. As described above, as the web browser process 202 is restarted, the memory used by the web browser process 202 is released.

In step S417, the web browser monitoring process 203 temporarily pauses the process for a predetermined time, and then the processing proceeds to step S404. As described above, the web browser monitoring process 203 establishes a monitoring interval by halting the process for the predetermined time.

The processing proceeds from step S417 to step S404 to restart the monitoring of the restarted web browser process 202.

In step S415, the web browser monitoring process 203 temporarily pauses the process for a predetermined time, and then the processing proceeds to step S404.

The set of processes illustrated in FIG. 4 is terminated in a case where the image processing apparatus 100 is turned off.

The web browser tends to use more memory than other applications. On the other hand, the process (the web browser process 202) making up the web browser typically has no impact on other processes, even when restarted. Considering the foregoing characteristics, the present embodiment restarts the web browser process 202 and releases the memory in a case where the capacity of the memory used by the web browser process 202 exceeds the threshold through the processes described above. Application of the foregoing control makes it possible to prevent forcible termination of the other process 204 by the OS 201 as a result of memory depletion, making it possible for the image processing apparatus 100 to operate stably.

While the present embodiment mainly describes an example of a case where the monitoring and restarting target is the web browser process 202, the monitoring and restarting target is not limited to the web browser process 202 and may be other processes. Specifically, substantially the same effect can be achieved by selecting, as a target of the above-described control, any process that tends to use more memory than other applications and typically has no impact on other processes even when the process is restarted.

In the first embodiment described above, the web browser monitoring process 203 is temporarily paused in step S415 in FIG. 4 to establish the monitoring interval of the web browser monitoring process 203. However, the capacity of the memory used by the web browser may exceed the memory usage threshold 206 while the web browser monitoring process 203 is temporarily paused.

Considering the foregoing situation, a second embodiment of the present disclosure describes an example of a case where the monitoring interval of the web browser monitoring process 203 is set shorter in a case where the capacity of the memory used by the web browser approaches the memory usage threshold 206. By applying the foregoing control, the present embodiment prevents the capacity of the memory used by the web browser from exceeding the memory usage threshold 206 while the web browser monitoring process 203 is temporarily paused.

The present embodiment will be described with a focus on the aspects that are particularly different from those of the first embodiment, and detailed descriptions of those that are substantially the same as the first embodiment are omitted.

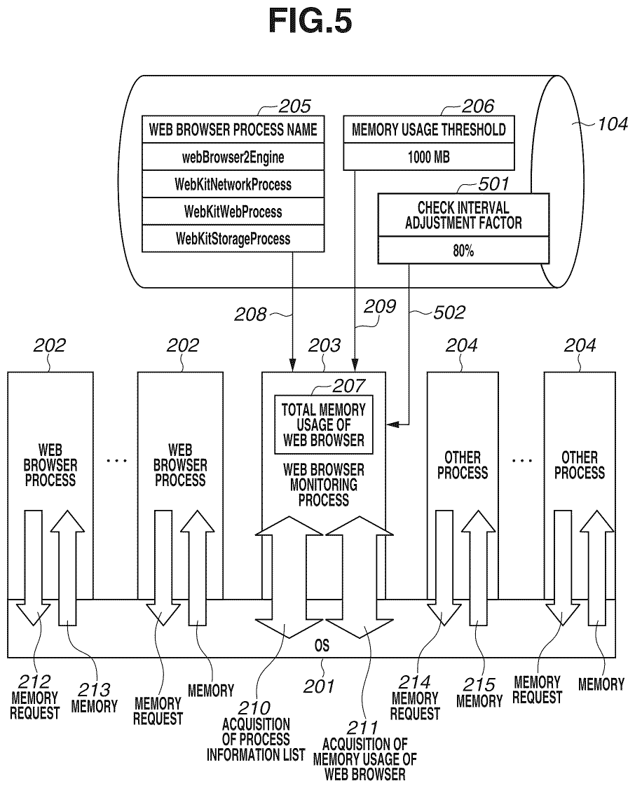

An example of a software configuration of the image processing apparatus 100 according to the present embodiment will be described below with reference to FIG. 5.

The web browser monitoring process (203) reads a check interval adjustment factor 501 from the external storage device 104, as indicated by reference numeral 502. The check interval adjustment factor 501 is a factor that is used by the web browser monitoring process 203 to determine whether to shorten a check interval (i.e., monitoring interval), and corresponds to the ratio between the capacity of the memory used by the web browser and the memory usage threshold 206.

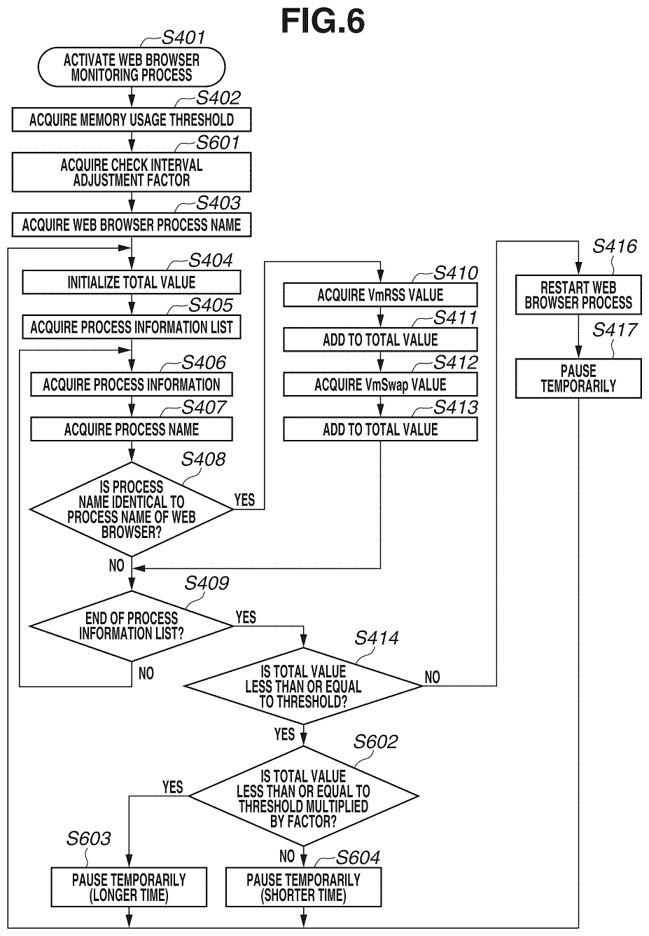

An example of a process of the image processing apparatus 100 according to the present embodiment will be described below with reference to FIG. 6, with a particular focus on the operations of the web browser monitoring process 203. In practice, the CPU 101 of the image processing apparatus 100 functions as the main entity responsible for the set of processes in the example illustrated in FIG. 6. For convenience, however, the web browser monitoring process 203 will be described as the main entity responsible for the processes.

After reading the memory usage threshold 206 in step S402, the web browser monitoring process 203 performs the process in step S601.

In step S601, the web browser monitoring process 203 reads the check interval adjustment factor 501 from the external storage device 104.

Further, in step S414, the web browser monitoring process 203 determines whether the total memory usage 207 of the web browser is less than or equal to the memory usage threshold 206. In a case where the web browser monitoring process 203 determines that the total memory usage 207 of the web browser is less than or equal to the memory usage threshold 206 (YES in step S414), the processing proceeds to step S602, whereas in a case where the web browser monitoring process 203 determines that the total memory usage 207 of the web browser is neither less than nor equal to the memory usage threshold 206 (NO in step S414), the processing proceeds to step S416. The processes in the case where the processing proceeds to step S416 are substantially the same as those in the example described above with reference to FIG. 4.

In step S602, the web browser monitoring process 203 determines whether the total memory usage 207 of the web browser is less than or equal to a value obtained by multiplying the memory usage threshold 206 by the check interval adjustment factor 501. In a case where the web browser monitoring process 203 determines that the total memory usage 207 of the web browser is less than or equal to the value obtained by multiplying the memory usage threshold 206 by the check interval adjustment factor 501 (YES in step S602), the processing proceeds to step S603, whereas in a case where the web browser monitoring process 203 determines that the total memory usage 207 of the web browser is neither less than nor equal to the obtained value (NO in step S602), the processing proceeds to step S604.

In step S603, the web browser monitoring process 203 temporarily pauses the process for a predetermined time, and then the processing proceeds to step S404.

In step S604, the web browser monitoring process 203 temporarily pauses the process for a shorter time than the temporary pause time in the process in step S603, and then the processing proceeds to step S404.

The foregoing processes make it possible to control the monitoring interval of the memory usage of the web browser by the web browser monitoring process 203 such that the monitoring interval is shortened based on the capacity of the memory used by the web browser. Specifically, in a case where the capacity of the memory used by the web browser process 202 approaches the memory usage threshold 206, the interval at which the determination processes described as step S414 in FIG. 6 are performed is shortened. Application of the foregoing control makes it possible to prevent the capacity of the memory used by the web browser from exceeding the memory usage threshold 206 while the web browser monitoring process 203 is temporarily paused.

Methods for setting the time for which the web browser monitoring process 203 temporarily pauses the process in step S604 are not particularly limited, and any time shorter than the predetermined time for which the process is temporarily paused in step S603 may be set. As a specific example, a fixed value may be applied as the temporary pause time. Further, as another example, the temporarily pause time may be determined dynamically based on the total memory usage 207 of the web browser. As a specific example, control may be applied such that the smaller the difference between the total memory usage 207 of the web browser and the value obtained by multiplying the memory usage threshold 206 by the check interval adjustment factor 501, the shorter the temporarily pause time.

Further, while the present embodiment describes an example of a case where the monitoring interval is controlled in two stages, the monitoring interval may be controlled in a plurality of stages such that the monitoring interval becomes shorter as the total memory usage 207 of the web browser approaches the memory usage threshold 206.

Further, while the processes illustrated in FIGS. 4 and 6 are described as being performed by the CPU 101 in practice, a single piece of hardware may perform the various types of control described above, or a plurality of pieces of hardware (e.g., a plurality of processors) may control the entire apparatus by sharing the processes.

Further, while the present disclosure has been described in detail above with reference to preferred embodiments of the disclosure, the present disclosure is not limited to these specific embodiments, and various forms within the gist of the disclosure are also encompassed within the scope of the present disclosure. Furthermore, each embodiment described above is merely an embodiment of the present disclosure and can be combined with another embodiment as appropriate.

Further, while the above-described embodiments provide examples of cases where the present disclosure is applied to an image processing apparatus, the present disclosure is not limited to these examples, and the present disclosure is applicable to any so-called information processing apparatus associated with memory management (particularly apparatuses with relatively small memory capacity).

Specifically, the present disclosure is applicable to personal computers, personal digital assistants (PDAs), mobile phone terminals, portable image viewers, printer apparatuses with displays, digital photo frames, music players, game machines, and electronic book readers.

The present embodiment makes it possible to ensure the stability of operation more effectively even in apparatuses with relatively small memory capacity.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-009390, filed Jan. 25, 2024, which is hereby incorporated by reference herein in its entirety.

What is claimed is:

1. An information processing apparatus comprising at least one memory and at least one processor which function as:
a first acquisition unit configured to acquire a first list containing information about each of processes in a set configured to be restarted;
a second acquisition unit configured to acquire a second list containing information about each of processes in a set in operation;
an extraction unit configured to extract one or more processes about which information is contained in the first list, from the set of processes about which information is contained in the second list;
a calculation unit configured to calculate total memory usage of each of the one or more processes extracted by the extraction unit;
a determination unit configured to determine whether the total memory usage calculated by the calculation unit exceeds a threshold; and
a restart unit configured to restart at least one of the one or more processes extracted by the extraction unit in a case where the determination unit determines that the total memory usage exceeds the threshold.

2. The information processing apparatus according to claim 1, wherein the first list at least contains information about a process of a web browser.

3. The information processing apparatus according to claim 1, wherein the calculation unit calculates a sum of physical memory usage and swap memory usage as the total memory usage.

4. The information processing apparatus according to claim 1, wherein the at least one memory and the at least one processor further function as a control unit configured to control an interval at which the determination unit sequentially determines whether the total memory usage exceeds the threshold,
wherein the control unit controls the interval to be shorter in a case where the total memory usage calculated by the calculation unit exceeds a value obtained by multiplying the threshold by a factor related to the control of the interval.

5. A method for controlling an information processing apparatus, the method comprising:
acquiring, as a first acquisition, a first list containing information about each of processes in a set configured to be restarted;
acquiring, as a second acquisition, a second list containing information about each of processes in a set in operation;
extracting one or more processes about which information is contained in the first list, from the set of processes about which information is contained in the second list;
calculate total memory usage of each of the one or more extracted processes;
determining whether the calculated total memory usage exceeds a threshold; and
restarting at least one of the one or more extracted processes in a case where the total memory usage is determined to exceed the threshold.

6. A non-transitory computer-readable storage medium storing instructions which, when executed by a computer to function as cause an information processing apparatus to perform a controlling method, the method comprising:
acquiring, as a first acquisition, a first list containing information about each of processes in a set configured to be restarted;
acquiring, as a second acquisition, a second list containing information about each of processes in a set in operation;
extracting one or more processes about which information is contained in the first list, from the set of processes about which information is contained in the second list;
calculate total memory usage of each of the one or more extracted processes;
determining whether the calculated total memory usage exceeds a threshold; and
restarting at least one of the one or more extracted processes in a case where the total memory usage is determined to exceed the threshold.
